(19) United States
(12) Patent Application Publication
(10) Pub. No.: US 2016/0053868 A1
(43) Pub. Date: Feb. 25, 2016

(54) Transmission for a Motor Vehicle

(71) Applicant: ZF FRIEDRICHSHAFEN AG, Friedrichshafen (DE)

(72) Inventors: Stefan Beck, Eriskirch (DE); Christian Sibla, Friedrichshafen (DE); Wolfgang Rieger, Friedrichshafen (DE)

(73) Assignee: ZF Friedrichshafen AG, Friedrichshafen (DE)

(21) Appl. No.: 14/780,761

(22) PCT Filed: Feb. 25, 2014
(86) PCT No.: PCT/EP2014/053567

§ 371 Date: Sep. 28, 2015

(30) Foreign Application Priority Data
Mar. 27, 2013 (DE) 10 2013 205 376.2

(51) Int. Cl. F16H 3/66

(52) U.S. Cl. CPC F16H 3/66; F16H 2200/0065; F16H 2200/2012; F16H 2200/2046

(57) ABSTRACT

The invention relates to a transmission, in particular a multi-clutch transmission for a motor vehicle, comprising the elements of drive shaft, several planetary gear sets, whereas one planetary gear set comprises the planetary elements of a sun gear, one or more planetary gears, one bar and one ring gear, N shift elements, comprising several clutches, whereas N is a whole number greater than four, and an output shaft, whereas, by means of at least one of the N shift elements, the drive shaft is connectable to the output shaft for the presentation of various gears by means of at least one of the planetary transmissions, whereas the N shift elements comprise at least M brakes and N−M clutches, whereas M is a whole number greater than or equal to one, and whereas at least (N−M)/2 clutches work together with the drive shaft and/or the output shaft.

The invention relates to a transmission, in particular a multi-clutch transmission for a motor vehicle, comprising the elements of a drive shaft, several planetary gear sets, whereas one planetary gear set comprises the planetary elements of a sun gear, one or more planetary gears, one bar and one ring gear, N shift elements, comprising several clutches, whereas N is a whole number greater than four, and an output shaft, whereas, by means of at least one of the N shift elements, the drive shaft is connectable to the output shaft for the presentation of various gears by means of at least one of the planetary transmissions.

Such transmissions are known, for example, from WO 2012/052284 A1. In WO 2012/052284 A1, a multi-speed transmission with six forward gears and one reverse gear is shown, which comprises four planetary gear sets, seven rotatable shafts and five shift elements, whereas the sun gear of the first planetary gear set is connected to the sixth shaft, which is attachable through a first brake to the housing of the transmission, whereas the bar of the first planetary gear set is connected to the fifth shaft, which is connected to the sun gear of the second planetary gear set and is attachable through a second brake to the housing, whereas the drive shaft is connected to the ring gear of the first planetary gear set and to the sun gear of the third planetary gear set and is detachably connectable through a clutch to the seventh shaft connected to the bar of the third planetary gear set and the ring gear of the fourth planetary gear set, whereas the fourth shaft is connected to the ring gear of the third planetary gear set and to the bar of the second planetary gear set and is connectable through a third brake to the housing, whereas the output shaft is connected to the ring gear of the second planetary gear set and to the bar of the fourth planetary gear set and whereas the sun gear of the fourth planetary gear set is connected to the third shaft, which is attachable through a fourth brake to the housing.

The disadvantage here is that shift elements, such as multi-disk clutches or brakes, are hydraulically actuated. This hydraulic actuation leads to high hydraulic losses. In order to avoid such actuation losses, providing electro-mechanical or electro-hydraulic actuation has been proposed. In turn, the disadvantage here is that the shift elements, primarily clutches, are difficult to access.

As such, one task of the present invention is to provide a transmission for a motor vehicle, which has a high degree of efficiency, low component stress and low construction costs. Moreover, it is one task of the present invention to provide a transmission for a motor vehicle that features good accessibility of shift elements from the outside. An additional task of the present invention is to provide an alternative transmission for a motor vehicle.

The present invention solves the problems for a transmission, in particular a multi-clutch transmission for a motor vehicle, comprising the elements of drive shaft, several planetary gear sets, whereas one planetary gear set comprises the planetary elements of a sun gear, one or more planetary gears, one bar and one ring gear, N shift elements, comprising several clutches, whereas N is a whole number greater than four, and an output shaft, whereas, by means of at least one of the N shift elements, the drive shaft is connectable to the output shaft for the presentation of various gears by means of at least one of the planetary transmissions, characterized in that the N shift elements comprise at least M brakes and N−M clutches, whereas M is a whole number greater than or equal to one, and that at least (N−M)/2 clutches work together with the drive shaft and/or the output shaft.

The invention also solves the task for a motor vehicle, in particular for a passenger car or a truck, with a transmission in accordance with one of the claims 1 to 23.

One of the advantages obtained thereby is that, in this manner, a good accessibility of all shift elements is ensured. In addition, the construction costs are low, which means lower costs and weight of the transmission.

In the description, in particular in the claims, “shift element” is preferably understood as a device that features at least one open and one locked state, whereas, in the open state, the device cannot transfer torque, and whereas in the locked state, the device can transfer torque between two devices (for example, shafts) working together with this device or the shift element, as the case may be.

In the description, in particular in the claims, “ring gear shaft” is preferably understood as a shaft that is connected to a ring gear of a planetary gear set for transferring power and torque. “Sun shaft” is understood as a shaft that is connected to a sun gear of a planetary gear set for transferring power and torque.

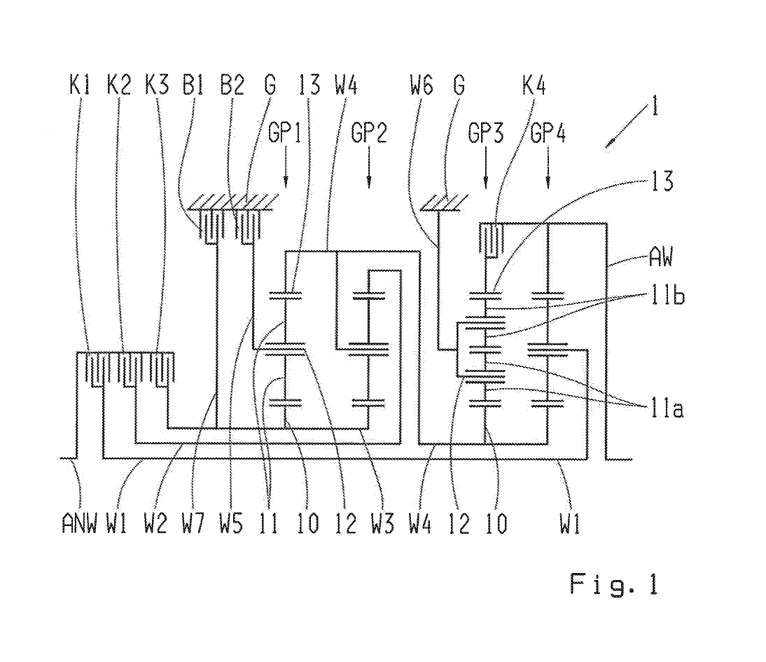

In the description, in particular in the claims, in particular preferably in the description for FIGS. 1-12, “between” is preferably understood in the technical sense of power and/or torque. Thus, if a device is arranged “between” two elements of the transmission, it is integrated or can be integrated in flow or power and torque between the two elements.

Additional advantageous embodiments, characteristics and advantages for the invention are described in the subclaims.

Beneficially, all the clutches work together with the drive shaft and/or the output shaft. In this manner, particularly good accessibility of the shift elements in the form of the clutches is ensured.

Advantageously, the majority of the clutches work together with the drive shaft. If the majority of the clutches is arranged in the area of the drive shaft, a particularly easy ability to reach or accessibility of the clutches from the outside is possible. In addition, they can be arranged in the transmission in a particularly simple manner.

Beneficially, a sun shaft is formed as a common sun shaft of at least two planetary gear sets. In this manner, a compact structure of the transmission is achieved. At the same time, a sufficient number of gears can be presented by the transmission.

Advantageously, a ring gear shaft is formed as a common ring gear shaft of at least two planetary gear sets. One of the advantages is that a sufficiently compact structure, with simultaneously a sufficient flexibility in terms of the provision of gears by the transmission, is thereby achieved.

Beneficially, the common ring gear shaft of at least two planetary gear sets is formed as a sun shaft for at least one additional planetary gear set. In this manner, a particularly simple and reliable transfer of power and torque between the two planetary transmissions and at least one additional planetary transmission is made possible.

Advantageously, a ring gear shaft is formed as an output shaft. In this manner, a reliable transfer of power and torque from the ring gear shaft of one of the planetary gear shafts to the output shaft can take place.

Beneficially, the bar of least one planetary gear set is connectable to the housing by means of one of the brakes, and/or the bar of at least one planetary gear set is firmly connected to the housing. Through this firm connection of the bar of at least one planetary transmission to the housing, a reliable support at the housing can take place. Using a brake, this support can be canceled, such that the flexibility of the transmission as a whole is further increased.

Advantageously, at least one sun shaft is firmly connectable to the housing by means of one of the brakes. One of the advantages obtained thereby is that, in a simple manner, the sun shaft of a planetary transmission can be supported on the housing by pressing one of the brakes.

Beneficially, at least one planetary gear set, in particular its ring gear, is connectable to the output shaft by means of at least one clutch. Thereby, in a flexible and reliable manner, a planetary element of a planetary transmission can be connected to the output shaft.

Advantageously, two planetary gear sets features stationary transmission ratios with different signs. The advantage here is that good transmission ratio series of different gears are made possible in a flexible manner.

Beneficially, the majority of the planetary gear sets, in particular at least three-quarters of the planetary gear sets, feature a negative stationary transmission ratio. Thereby, the ring gear, with a stationary bar, features a direction of rotation counter to the sun gear, which enables a reliable transmission of power and torque between the sun gear and the ring gear.

Advantageously, by means of a clutch, which is arranged upwards or downwards of one planetary element of a planetary gear set, power and torque of the drive shaft can be decoupled from the additional elements of the transmission. In this manner, the clutch can be arranged at different positions in the transmission, depending on external requirements, which increases the flexibility of the transmission when installed in different vehicles, without thereby reducing the number of gears that are presented by the transmission.

Beneficially, by means of a clutch, sun shafts of two planetary gear sets are connectable to a common sun shaft. This increases the flexibility of the transmission, since, depending on the need, a second planetary transmission with the same sun shaft can be subjected to power and torque, such that additional gears can be presented.

Advantageously, by means of at least one clutch, preferably at least two clutches, one planetary element of a planetary gear set, preferably planetary elements of different planetary gear sets, is connectable to the output shaft, whereas the planetary element is preferably a ring gear. Thus, the flexibility of the transmission with respect to ability to present various gears is further increased, since, depending on the need, one or more planetary gear sets can be coupled with the output shaft.

Beneficially, by means of at least one clutch, a bar of a planetary gear set is connectable with a sun shaft, in particular a common sun shaft. One of the advantages obtained thereby is that, in a particularly simple and reliable manner, several planetary gear sets can be connected to each other. In addition, several and/or additional gears can thereby be provided by the transmission.

Advantageously, at least one planetary gear set features a positive stationary transmission ratio. One of the advantages obtained thereby is that, for example, with a stationary bar, the ring gear of the planetary gear set features the same direction of rotation as the sun gear.

Beneficially, one planetary element of the planetary gear set, in particular its ring gear, is connectable with a positive stationary transmission ratio by means of a clutch to the output shaft. Through the positive stationary transmission ratio, for example, the planetary gear set can be coupled to the output shaft by means of the clutch, such that the output shaft features the same direction of rotation as the sun shaft of the planetary gear set.

Advantageously, at least two of the M brakes, preferably all brakes, work together with the planetary elements of a same planetary gear set. In this manner, the installation space of the transmission can be further reduced, while the accessibility of the brakes can be improved, since they are now located or arranged in the area of the respective planetary gear set.

Beneficially, by means of the N shift elements and the planetary gear sets, at least ten gears can be presented, in particular at least nine forward gear ratios and at least one reverse gear. In this manner, a sufficient number of forward gears and reverse gears is provided by the transmission, such that the transmission can be flexibly used in a variety of vehicles.

Advantageously, at least one gear, in particular one forward gear, can be presented by at least two, in particular four different actuations of the N shift elements. In this manner, a redundancy of at least one gear is ensured, such that, even upon a failure of one of the shift elements, the gear can be represented by the other shift elements.

Beneficially, all brakes of a presentation of at least one gear are open. Thus, the wear of the brakes can be reduced, since no actuation of the brakes must be carried out during the operation of such gear.

Advantageously, at least one shift element, in particular at least half of the shift elements, are designed as claw shift elements, preferably comprising at least one brake and at least one clutch. This leads to significant consumption advantages of a motor vehicle provided with the transmission

Additional important characteristics and advantages of the invention arise from the subclaims, from the drawings, and from the associated description of the figures on the basis of the drawings.

It is understood that the characteristics specified above and the characteristics that are still to be described below are usable not only in the indicated combination, but also in other combinations or alone, without leaving the framework of the present invention.

Preferred designs and embodiments of the invention are presented in the drawings and are described more specifically in the following description, whereas the same reference signs refer to identical or similar or functionally identical components or elements.

The following are shown, each in schematic form:

FIG. 1 a transmission in accordance with a first embodiment of the present invention;

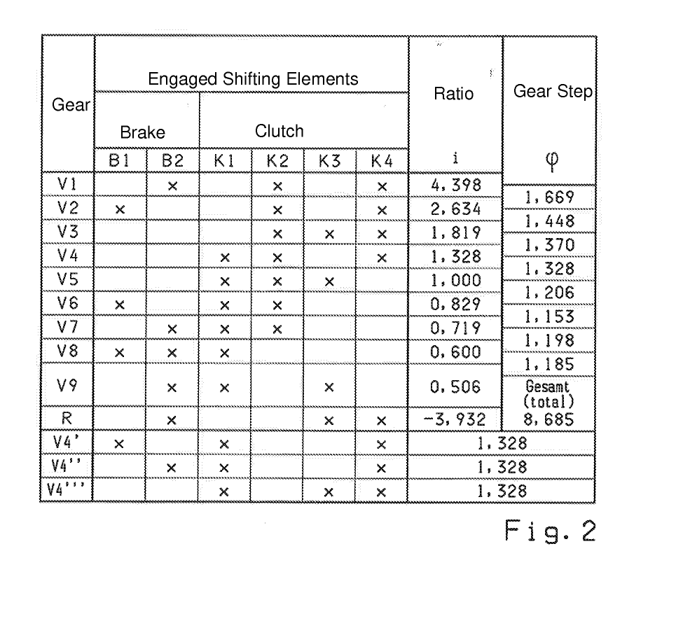

FIG. 2 a shifting matrix for a transmission in accordance with the first embodiment of the present invention;

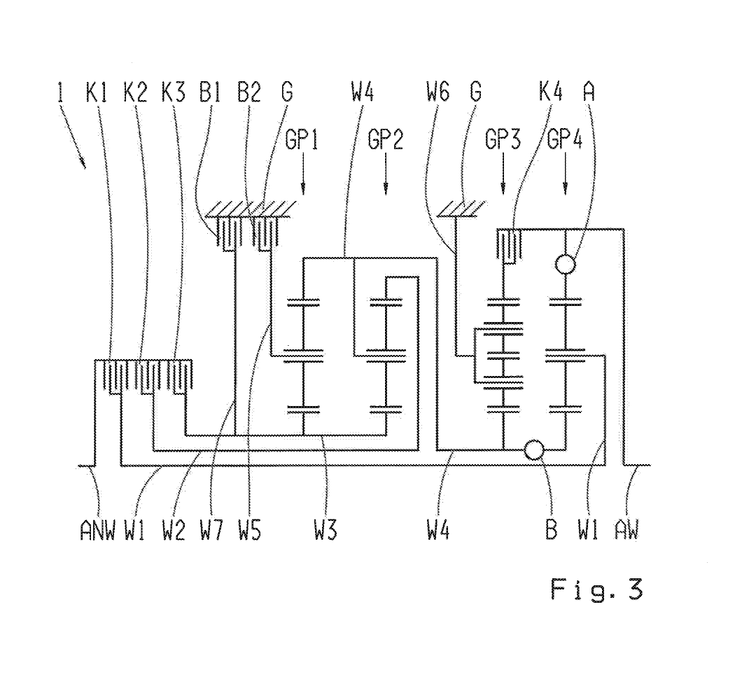

FIG. 3 a transmission in accordance with a second embodiment of the present invention;

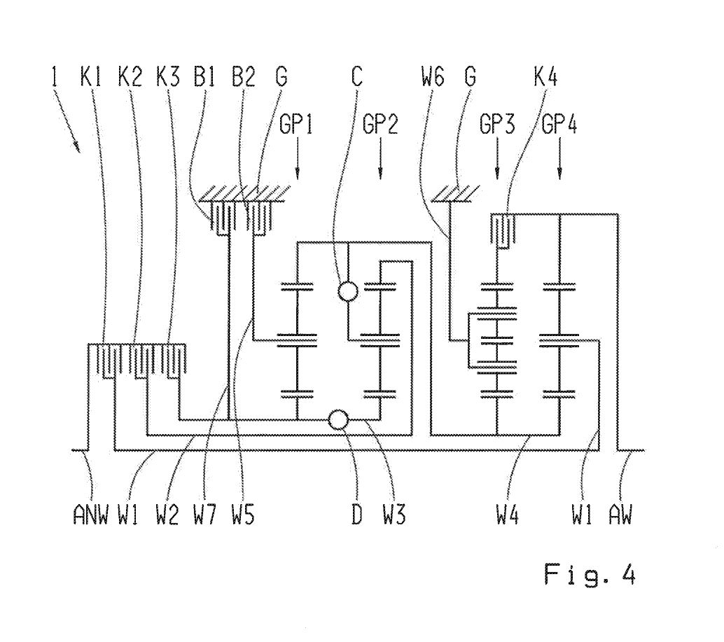

FIG. 4 a transmission in accordance with a third embodiment of the present invention;

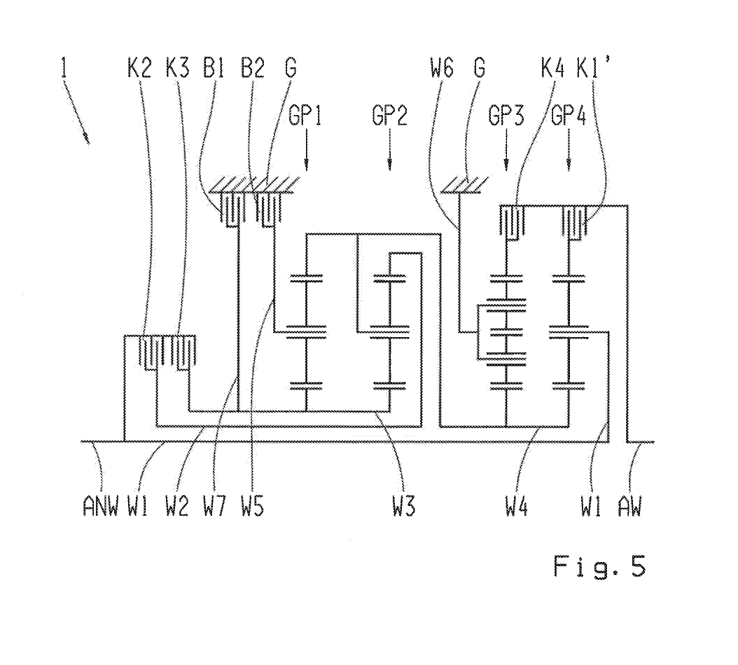

FIG. 5 a transmission in accordance with a fourth embodiment of the present invention;

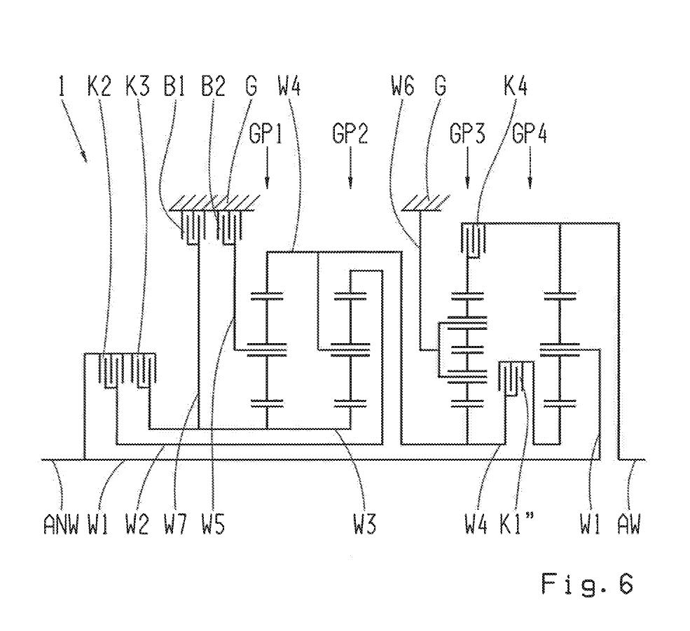

FIG. 6 a transmission in accordance with a fifth embodiment of the present invention;

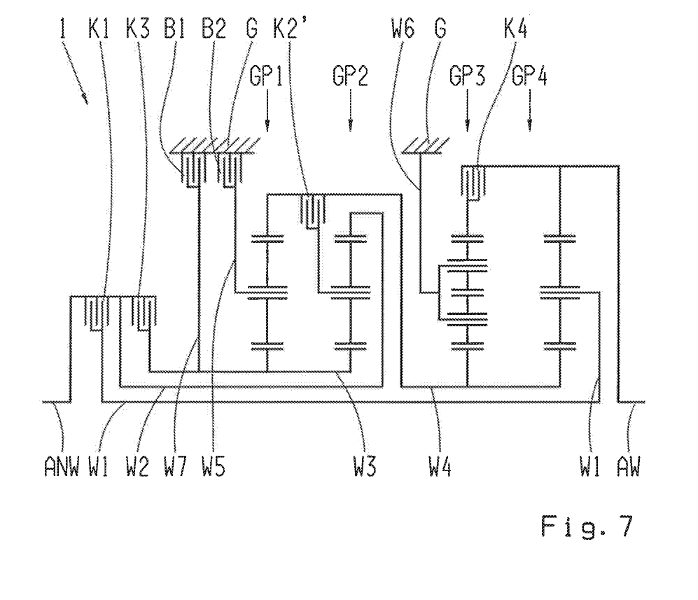

FIG. 7 a transmission in accordance with a sixth embodiment of the present invention;

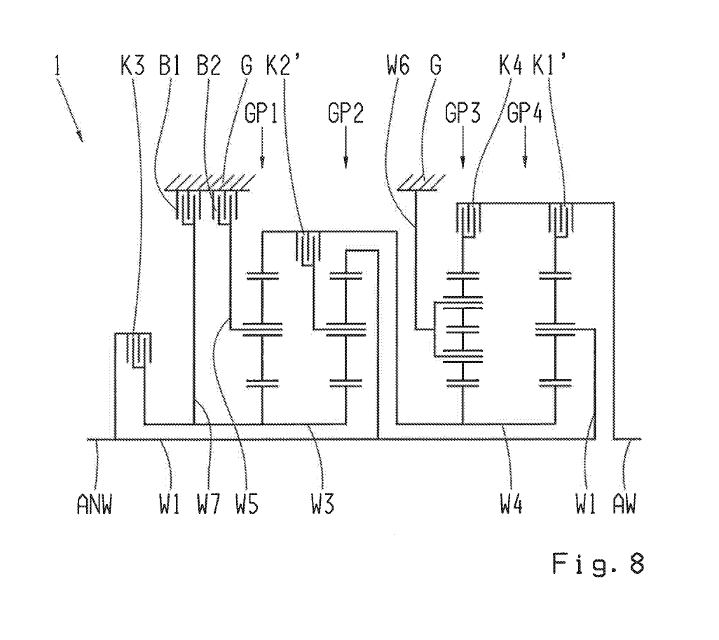

FIG. 8 a transmission in accordance with a seventh embodiment of the present invention;

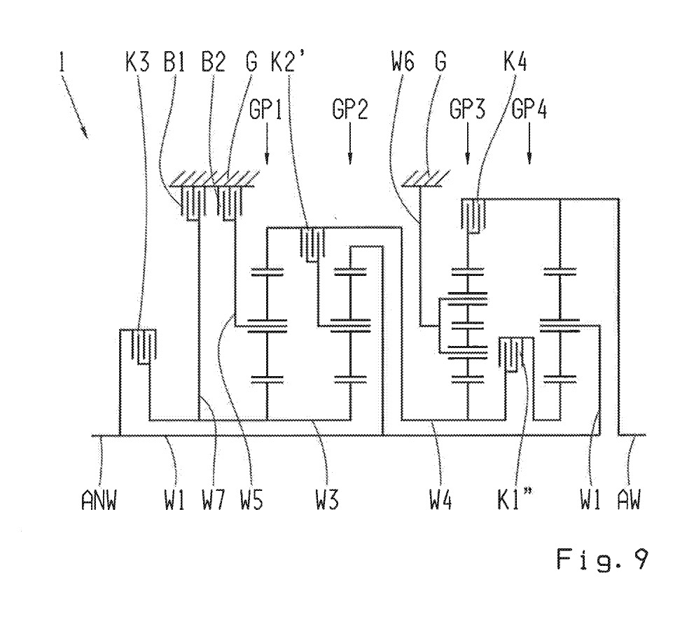

FIG. 9 a transmission in accordance with an eighth embodiment of the present invention;

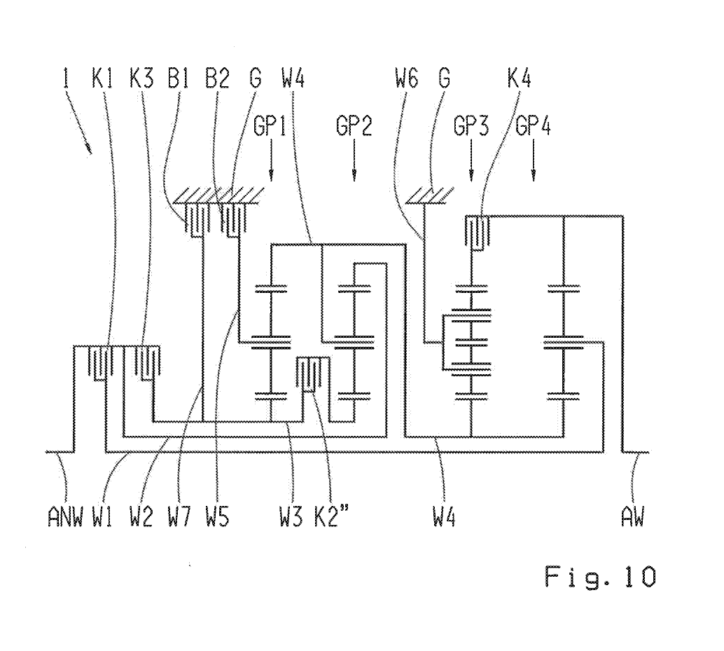

FIG. 10 a transmission in accordance with a ninth embodiment of the present invention;

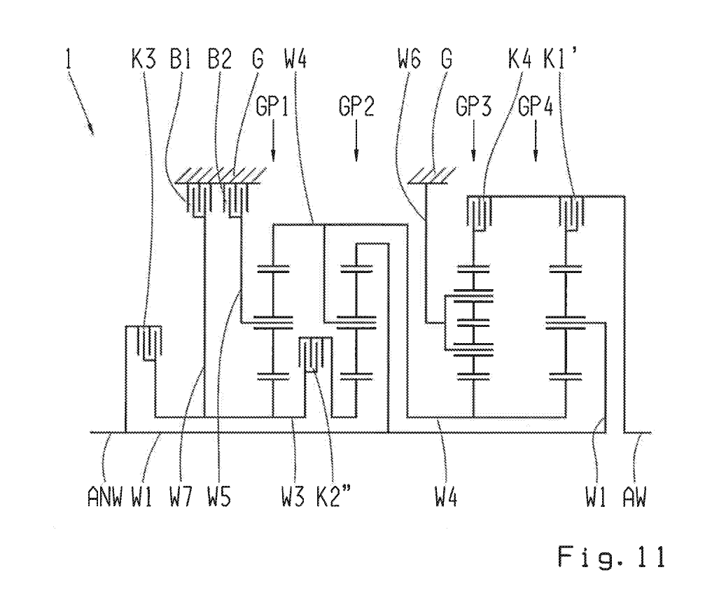

FIG. 11 a transmission in accordance with a tenth embodiment of the present invention;

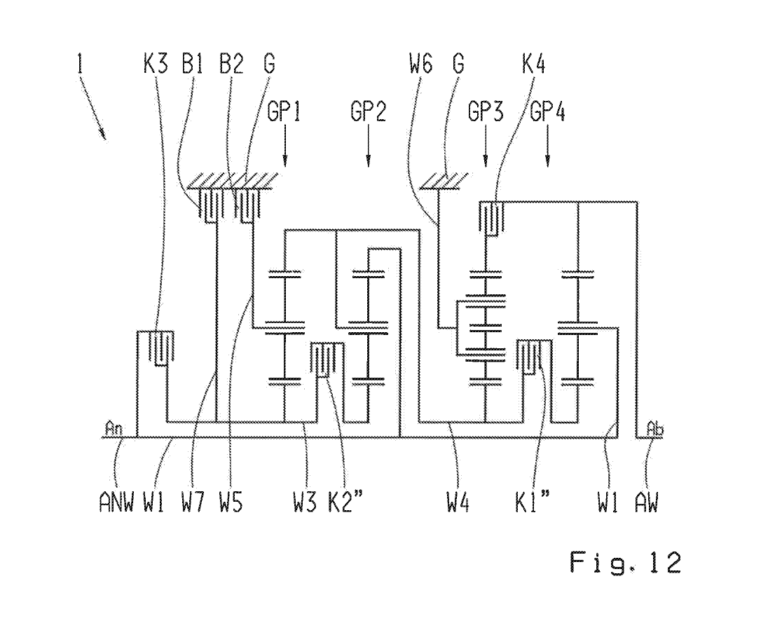

FIG. 12 a transmission in accordance with an eleventh embodiment of the present invention;

FIG. 1 shows a transmission in accordance with a first embodiment of the present invention.

In FIG. 1, reference sign 1 designates a multi-speed transmission. The multi-stage transmission 1 features six power-shifting elements in the form of four clutches K1, K2, K3, K4 and two brakes B1, B2. By means of the four clutches K1, K2, K3, K4, the drive side can be coupled or connected to the output side of the transmission 1 for transferring power and torques. For this purpose, the first clutch K1, the second clutch K2 and the third clutch K3 are connected to the drive shaft ANW on the drive side. The first clutch K1 is also connected to a first shaft W1, such that, when actuated, the clutch transfers power and torque from the drive shaft ANW to the first shaft W1. This correspondingly applies for the second clutch K2 and the third clutch K3. Upon locking the second clutch K2, power is transferred from the drive shaft ANW to the second shaft W2; upon locking the third clutch K3, power and torque are transferred from the drive shaft ANW to the third shaft W3.

In the transmission 1, four planetary gear sets GP1, GP2, GP3 and GP4 and seven shafts W1, W2, W3, W4, W5, W6 and W7 are also arranged.

Below, the general structure of the first planetary gear set GP1 and the second planetary gear set GP2 along with fourth planetary gear set GP4 will initially be described. The planetary gear sets GP1, GP2 and GP4 specified above are constructed in the usual manner, and in each case feature a central sun gear 10, which interacts with one or more planetary gears 11 for the transfer of power and torques. The one or more planetary gears 11 are rotatably mounted on a bar 12. On the radially outer side of the one or more planetary gears 11, a ring gear 13 is arranged, in which the one or more planetary gears 11 is/are engaged for the transfer of power and torques. The bar or planetary carrier 12, as the case may be, is further connected to a shaft.

The structure of the third planetary gear set GP3 is as follows: the third planetary gear is constructed essentially like the other planetary gear sets GP1, GP2 and GP4 in the usual manner, and comprises a central sun gear 10, in which at least one planetary gear 11a engages. In the first planetary gear 11a, at least one second planetary gear 11b engages for transferring power and torque. The planetary gears 11a and 11b are rotatably mounted on a common bar 12. On the radially outer side of the planetary gear(s) 11b, a ring gear is in turn arranged, in which the planetary gear(s) 11b engage(s). The bar 12 and the planetary carrier are firmly connected through the sixth shaft W6 to the housing G of the transmission 1.

The seven different shafts W1, W2, W3, W4, W5 and W6 along with W7 will then be described.

The first shaft W1 connects the first clutch K1 and the bar of the fourth planetary gear set GP4 for transferring power and torque. The second shaft W2 connects the second clutch K2 and the ring gear of the second planetary gear set GP2 for transferring power and torque. The third shaft W3 connects the third clutch K3 to the sun gears 10 of the first planetary gear set GP1 and the second planetary gear set GP2. The fourth shaft W4 connects the ring gear of the first planetary gear set GP1 and the bar of the second planetary gear set GP2 to the sun gear of the third planetary gear set GP3 and the fourth planetary gear set GP4. The fifth shaft W5 is, on the one hand, connectable through the second brake B2 to the housing G and, on the other hand, connected to the bar of the first planetary gear set GP1. The sixth shaft W6 is firmly connected to the bar of the third planetary gear set GP3 on the one hand and to the housing G on the other hand. The seventh shaft W7 is, on the one hand, connected to the third shaft W3 and, on the other hand, firmly connectable through the first brake B1 to the housing G. The output shaft AW is connected, on the one hand, through a fourth clutch K4 to the ring gear of the third planetary gear set GP3 and, on the other hand, to the ring gear of the fourth planetary gear set GP4.

FIG. 2 shows a shifting matrix for a transmission in accordance with the first embodiment of the present invention.

FIG. 2 presents a shifting matrix for a transmission 1 in accordance with FIG. 1. Downwards in a vertical direction to this, nine forward gears, designated with the reference signs V1 to V9, and one reverse gear designated with R, are initially shown. Furthermore, three alternative presentations for the fourth forward gear V4, designated with the reference sign V4′, V4″, V4′″, are shown. The respective shift elements are shown horizontally, whereas the first two brakes B1 and B2 and then the four clutches K1, K2, K3 and K4 are initially shown. Furthermore, the respective transmission ratio relationship/ratio i and the corresponding gear jump/step φ is shown between two consecutive gears/gear steps. In this respect, the respective gear jump is presented in the shifting matrix, in each case between two gears. With the alternative presentations of the fourth forward gear V4, only the transmission ratio is indicated.

The entries left empty in the shifting matrix, thus, for example, with the forward gear V1, with the first brake B1 along with the first clutch K1 and the third clutch K3 indicate that the corresponding shift element or brake or clutch, as the case may be, is open; i.e., that the shift element thereby does not transfer any power or torque from the respective shafts or elements of the transmission attached to the shift element or connected to it. An entry in the shifting matrix provided with a cross designates a correspondingly actuated or locked shift element, thus in the shifting matrix, for example, with the forward gear V1, with the clutches K2 and K4 and with the brake B2.

In order to present the first forward gear V1 by means of the transmission 1 in accordance with FIG. 1, the brake B2 and the clutch K2 and K4 are locked. The transmission ratio relationship i is 4.398. In order to present the second gear V2, the brake B1 and the clutch K2 and K4 are locked. The transmission ratio relationship i is 2.634.

In order to present the third forward gear V3, the clutches K2, K3 and K4 are locked. The transmission ratio relationship i is 1.819. In order to present the fourth gear V4, the clutch K1, the clutch K2 and the clutch K4 are locked. The transmission ratio relationship i is 1.328.

In order to present the fifth forward gear V5, the clutches K1, K2 and K3 are locked. The transmission ratio relationship i is 1.000. In order to present the sixth forward gear V6, the first brake B1 and the clutches K1, K2 are locked. The transmission ratio relationship i is 0.829.

In order to present the seventh forward gear V7, the brake B2 and the clutches K1, K2 are locked. The transmission ratio relationship i is 0.719. In order to present the eighth forward gear V8, the two brakes B1, B2 and the clutch K1 are locked. The transmission ratio relationship i is 0.600. In order to present the ninth forward gear V9, the brake B2 and the clutches K1 and K3 are locked. The transmission ratio relationship i is 0.506.

In order to present the reverse gear R, the brake B2 and the clutches K3 and K4 locked. The transmission ratio relationship i is −3.932. In order to present the fourth forward gear V4, the brake B1 and the clutches K1 and K4 are locked. The transmission ratio relationship i is 1.328. In order to present the fourth forward gear V4″, the brake B2 and the clutches K1 and K4 are locked. The transmission ratio relationship i is 1.328. In order to present the fourth forward gear V4″, the clutches K1, K3 and K4 are locked and the transmission ratio relationship i is 1.328.

The gear jump φ between the first forward gear V1 and the second forward gear V2 is 1,669, and between the second forward gear V2 and the third forward gear V3 is 1.448. The gear jump φ between the third forward gear V3 and the fourth forward gear V4 is 1.370, and between the fourth forward gear V4 and the fifth forward gear V5 is 1.328. The gear jump φ between the fifth forward gear V5 and the sixth forward gear V6 is 1.206, and between the sixth forward gear V6 and the seventh forward gear V7 is 1.153. The gear jump φ between the seventh forward gear V7 and the eighth forward gear V8 is 1.198, and between the eighth forward gear V8 and the ninth forward gear V9 is 1.185. The entire gear jump amounts to 8.685.

Thereby, the first planetary gear set GP1 features a stationary transmission ratio of i₀=−2.162, the second planetary gear set GP2 features a stationary transmission ratio of i₀=−2.231, the third planetary gear set GP3 features a stationary transmission ratio i₀=−1.819 and the fourth planetary gear set GP4 features a stationary transmission ratio of i₀=−1.500.

FIG. 3 shows a transmission in accordance with a second embodiment of the present invention.

FIG. 3 shows a transmission 1 in accordance with FIG. 1. In contrast to the transmission 1 in accordance with FIG. 1, two positions A and B for the clutch K1 can be viewed, with which the first clutch K1 can be arranged in a manner effectively equal to the position in accordance with FIG. 1.

The first alternative position A for the first clutch K1 is between the ring gear of the fourth planetary gear set GP4 and the output shaft AW, and the second position B for the first clutch K1 is between the sun gear of the third planetary gear set GP3 and the sun gear of the fourth planetary gear set GP4 on the fourth shaft W4, such that the ring gear and the output shaft, or the two sun gears, as the case may be, can be coupled with one another by means of the first clutch K1.

FIG. 4 shows a transmission in accordance with a third embodiment of the present invention.

FIG. 4 shows a transmission 1 in accordance with FIG. 1. In contrast to the transmission 1, in accordance with FIG. 1, two positions C and D for the clutch K2 can be viewed, with which the second clutch K2 can be arranged in a manner equally effective. The first alternative position C for the second clutch K2 is between the bar of the second planetary gear set GP2 and the fourth shaft W4, the second position D for the second clutch K2 is between the sun gear of the first planetary gear set GP1 and sun gear of the second planetary gear set GP2 at the third shaft W3, such that the bar and the fourth shaft or the two sun gears, as the case may be, can be coupled with one another.

FIG. 5 shows a transmission in accordance with a fourth embodiment of the present invention.

In FIG. 5, the first clutch K1 is arranged at the position A in accordance with FIG. 3, here designated with the reference sign K1′. The drive shaft ANW is thus directly connected to the bar of the fourth planetary gear set GP4 through the first shaft W1.

FIG. 6 shows a transmission in accordance with a fifth embodiment of the present invention.

In FIG. 6, the first clutch K1 is arranged at the position B in accordance with FIG. 3, here designated with the reference sign K1″. The drive shaft ANW is thereby connected through the first shaft W1 directly to the bar of the fourth planetary gear set GP4. The first clutch K1 is arranged at the fourth shaft W4 between the sun gear of the third planetary gear set GP3 and the sun gear of the fourth planetary gear set GP4.

FIG. 7 shows a transmission in accordance with a sixth embodiment of the present invention.

In FIG. 7, the second clutch K2 is now arranged at the position C in accordance with FIG. 4, here designated with the reference sign K2′. The drive shaft ANW is thus connected through the second shaft W2 directly to the ring gear of the second planetary gear set GP2. The bar of the second planetary gear set GP2 is connectable through the second clutch K2 to the fourth shaft W4.

FIG. 8 shows a transmission in accordance with a seventh embodiment of the present invention.

In FIG. 8, the second clutch K2, here designated with the reference sign K2′, is arranged at the position C in accordance with FIG. 4, and the first clutch K1, here designated with the reference sign K1′, is arranged at the position A in accordance with FIG. 3.

FIG. 9 shows a transmission in accordance with an eighth embodiment of the present invention.

In FIG. 9, the first clutch K1 is arranged at the position B in accordance with FIG. 3, here designated with the reference sign K1″, and the second clutch K2 is arranged at the position C in accordance with FIG. 4, here designated with the reference sign K2′.

FIG. 10 shows a transmission in accordance with a ninth embodiment of the present invention.

In FIG. 10, the second clutch K2 is arranged at the position D in accordance with FIG. 4, here designated with the reference sign K2″. The second clutch K2″ is thus arranged between the sun gear of the first planetary gear set GP1 and the sun gear of the second planetary gear set GP2 at the third shaft W3, and enables a connection for transferring power and torque between the sun shaft of the first and second planetary gear sets GP1, GP2.

FIG. 11 shows a transmission in accordance with a tenth embodiment of the present invention.

In FIG. 11, the clutch K1 is arranged at the position A in accordance with FIG. 3, here designated with the reference sign K1′, and the clutch K2 is arranged at the position D in accordance with FIG. 4, here designated with the reference sign K2″.

FIG. 12 shows a transmission in accordance with an eleventh embodiment of the present invention.

In FIG. 12, the first clutch K1 is arranged at the position B in accordance with FIG. 3, here designated with the reference sign K1″, and the clutch K2 is arranged at the position D in accordance with FIG. 4, here designated with the reference sign K2″.

Overall, the transmission 1 in accordance with FIGS. 1 to 12 comprises four planetary gear set levels GP1, GP2, GP3, GP4, six shift elements B1, B2, K1, K2, K3, K4, whereas the shift elements are designed in the form of four clutches K1, K2, K3, K4 and two brakes B1, B2. Furthermore, a fixed housing clutch in the form of the sixth shaft W6 is present. Finally, two shift elements to be shifted simultaneously are arranged.

As a start-up element for the transmission 1, a hydrodynamic torque converter, a hydrodynamic clutch, an additional start-up clutch, an integrated start-up clutch or brake and/or an additional electrical motor can be arranged. An electrical motor or another power source is arranged at each of the six shafts W1 to W7. Moreover, at each of the shafts W1 to W7, a freewheel is arranged for the housing G or for an additional shaft W1, W2, W3, W4, W5, W6, W7. The transmission 1 may be preferentially incorporated into a motor vehicle in standard drive design or in front-transverse design. Frictional-locking or positive-locking shift elements are possible as shift elements. In particular, the second brake B2, the second clutch K2 and the fourth clutch K4 may be designed as positive-locking shift elements, in particular as a claw shift element, which leads to significant consumption advantages of a motor vehicle with an internal combustion engine provided with the transmission.

In summary, the present invention offers the advantage that low construction costs are required for the transmission, which results in lower manufacturing costs and a lower weight of the transmission. Moreover, the transmission provides a good transmission ratio sequence, low absolute and relative rotational speeds and low planetary set torques and shift element torques. Moreover, the present invention provides good gearing efficiency and a very good accessibility of all of the shift elements, in particular regarding their maintenance.

Although the present invention was described above on the basis of preferred embodiments, it is not limited to them, but can be modified in many ways.

For example, the geometric position/order of the individual planetary gear sets GP1, GP2, GP3, GP4, and the individual shift elements K1, K2, K3, K4, B1, B2 may be freely selected under consideration of the binding ability of the respective transmission elements among each other. Individual transmission elements may be arbitrarily moved into their location/position within the transmission 1.

### REFERENCE SIGNS

1 Transmission
GP1, GP2, GP3, GP4 Planetary gear set
10 Sun gear
11, 11a, 11b Planetary gear
12 Bar
13 Ring gear
ANW Drive shaft
AW Output shaft
B1, B2 Brake
K1, K2, K3, K4 Clutch
G Housing
V1, V2, V3, V4, V5, V6, V7,
V8, V9, V4′, V4″, V4′″ Forward gear
R Reverse gear
W1, W2, W3, W4, W5, W6, W7 Shaft
i Transmission ratio/ratio
φ Gear jump/step
A, B, C, D Position of clutch

1. Transmission (1), in particular a multi-speed transmission for a motor vehicle, comprising the elements of a drive shaft (ANW), several planetary gear sets (GP1, GP2, GP3), whereas one planetary gear set comprises the planetary elements of a sun gear (10), one or more planetary gears (11, 11a, 11b), one bar (12) and one ring gear (13), N shift elements (B1, B2, K1, K2, K3, K4), comprising several clutches (K1, K2, K3, K4), whereas N is a whole number greater than four, and an output shaft (AW), whereas, by means of at least one of the N shift elements (B1, B2, K1, K2, K3, K4), the drive shaft (ANW) is connectable to the output shaft (AW) for the presentation of various gears (V1, V2, V3, V4, V5, V6, V7, V8, V9, V4′, V4″, V4′″) by means of at least one of the planetary transmissions (GP1, GP2, GP3, GP4), characterized in that the N shift elements (B1, B2, K1, K2, K3, K4) comprise at least M brakes (B1, B2) and N−M clutches (K1, K2, K3, K4), whereas M is a whole number greater than or equal to one, and that at least (N−M)/2 clutches work together with the drive shaft (ANW) and/or the output shaft (AW).

2-24. (canceled)
